(19) United States
(12) Patent Application Publication
(10) Pub. No.: US 2021/0379700 A1
(43) Pub. Date: Dec. 9, 2021

(54) METHOD FOR MACHINING A METAL CERAMIC SUBSTRATE, SYSTEM FOR CARRYING OUT SAID METHOD, AND METAL-CERAMIC SUBSTRATE MANUFACTURED BY USING SAID METHOD

(71) Applicant: Rogers Germany GmbH, Eschenbach (DE)

(72) Inventors: Thomas Kohl, Auerbach (DE); Daniel Küfner, Bayreuth (DE)

(21) Appl. No.: 17/266,017

(22) PCT Filed: Jul. 26, 2019
(86) PCT No.: PCT/EP2019/070257

§ 371 Date: Feb. 4, 2021

(30) Foreign Application Priority Data
Aug. 8, 2018 (DE) 10 2018 119 313.0

(51) Int. Cl. B23K 26/364; B23K 26/402; B23K 26/03; B23K 26/0622; G01B 11/22; G01B 11/06; B23Q 7/02

(52) U.S. Cl. CPC B23K 26/364; B23K 26/402; B23K 26/032; B23Q 7/02; G01B 11/22; G01B 11/06; B23K 26/0624

(57) ABSTRACT

A method of processing a metal-ceramic substrate (1), comprising: processing the metal-ceramic substrate (1) by irradiating the metal-ceramic substrate (1) with laser light, in particular for forming a predetermined breaking point (5); wherein a surface topography of the metal-ceramic substrate (1) is measured at least in regions in a first measuring step preceding the irradiation and/or in a second measuring step following the irradiation.

### CROSS-REFERENCE TO RELATED APPLICATIONS

This application is a National Stage filing of PCT/EP2019/070257, filed Jul. 26, 2019, which claims priority to DE 10 2018 119 313.0, filed Aug. 8, 2018, both of which are incorporated by reference in their entirety herein.

### BACKGROUND

The present invention relates to a method of processing a metal-ceramic substrate, a system for carrying out the method, and a metal-ceramic substrate produced by the same method.

Metal-ceramic substrates are well known from the prior art, for example as printed circuit boards or circuit boards. Typically, connection areas for electrical components and conductor tracks are arranged on one component side of the metal-ceramic substrate, whereby the electrical or electronic components and the conductor tracks can be interconnected to form electrical circuits. Essential components of the metal-ceramic substrates are an insulating layer, which is usually made of a ceramic, and one or more metal layers bonded to the insulating layer. Because of their comparatively high insulation strengths, insulation layers made of ceramics have proved to be particularly advantageous. By structuring the metal layer, conductive tracks and/or connection areas for the electrical components can be realized.

In particular, it is known from the prior art to bond copper to a ceramic layer by means of a DCB (“direct copper bond”) process to form a copper-ceramic substrate.

Typically, the ceramic layer and the metal layer are provided as a precomposite which is subjected to the bonding process, for example the DCB process, when passing through a furnace, in particular a continuous furnace. It is also possible to fabricate the metal-ceramic substrate by an active metal brazing (ABM=active metal brazing) process by bonding the metal layer to the ceramic layer via an active solder. The manufactured metal-ceramic substrates are usually produced as a large plate and subsequently divided into individual metal-ceramic substrate sections by breaking or cutting them apart or separating them from each other.

For this purpose, it has proven advantageous to provide a predetermined breaking point in the metal-ceramic substrate, in particular between two later metal-ceramic substrate sections. The two metal-ceramic substrate sections concerned are then broken apart along this predetermined breaking point. The formation of such a predetermined breaking point by means of laser illumination, in particular using an ultrashort pulse laser source, is known from the publications WO 2017 108 950 and DE 10 2013 104 055 A1, with which thinner structures serving as predetermined breaking points can be realized compared to the use of CO₂ lasers.

### SUMMARY

Based on this prior art, the present invention has the object to further improve the processes for processing metal-ceramic substrates, in particular with regard to a process reliability during breaking and a manufacturing process during the generation of structures by means of laser light, which serve as predetermined breaking points.

This object is solved by a method for processing metal-ceramic substrates as described herein, a system for carrying out the method according to claim as described herein and a metal-ceramic substrate as described herein. Further advantages and features of the invention result from the claims and subclaims as well as the description and the accompanying figures.

According to the invention, a method for processing a metal-ceramic substrate is provided, comprising:

processing the metal-ceramic substrate by irradiating the metal-ceramic substrate with laser light, in particular to form a predetermined breaking point; wherein in a first measuring step preceding the irradiation and/or in a second measuring step following the irradiation, a surface topography of the metal-ceramic substrate is measured at least in regions.

### BRIEF DESCRIPTION OF THE FIGURES

Further advantages and features result from the following description of preferred embodiments of the object according to the invention with reference to the attached figures. Individual features of the individual embodiment can thereby be combined with each other within the scope of the invention, which show:

FIG. 1: a part of a plant for the production and processing of metal-ceramic substrates

FIG. 2 Method for processing metal-ceramic substrates according to a preferred embodiment of the present invention.

FIG. 3 schematic representation of an exemplary first measurement step for the method according to a further preferred embodiment of the present invention

FIG. 4 schematic representation of an exemplary second measurement step for the method according to a further preferred embodiment of the present invention.

FIG. 5 schematic representation of a setup for determining the distance of a surface to a sensor.

### DETAILED DESCRIPTION

In contrast to the prior art, the surface topography of the metal-ceramic substrate is advantageously examined before irradiation by means of the first measuring step and/or after irradiation by means of the second measuring step. In the determination prior to irradiation, it is thereby advantageously possible to determine a position of the ceramic layer as precisely as possible. This position or orientation, respectively, of the ceramic layer can then be used in an advantageous manner to specifically set a focus for irradiation on a desired plane. The examination after irradiation allows defects to be identified at an early stage and defective metal-ceramic substrates to be sorted out.

It has been found that by performing the first measurement step and/or the second measurement step, a lower tolerance can be produced with respect to the scattering of the structures produced by the irradiation, in particular at a time before the metal-ceramic substrate is broken or separated. In particular, the reduced scattering relates to parameters such as a structure or scribe depth and a position of the structure between two metal-ceramic sections still to be separated. For example, tolerances of less than 20 μm (for a structure depth of 60 μm) can be achieved. Furthermore, the measured depth of the structure, for example, already indicates whether breaking is successful and, under certain circumstances, breaking that would destroy the metal-ceramic substrate anyway can be dispensed with here. As a result, the number of failures or ejections is reduced, i.e. efficiency in the production of the metal-ceramic section is increased.

In particular, the surface topography is to be understood as a profile course of the metal-ceramic substrate along its main extension plane, i.e., information about the outer side course of the metal-ceramic substrate is collected and provided by the first measuring step and/or the second measuring step, for example via a display device, wherein the outer side course is determined, for example, by the metallization on the ceramic layer or a structure generated by the irradiation.

Preferably, the first measuring step is performed immediately before irradiation and/or the second measuring step is performed immediately after irradiation. In particular, “immediately before and after” is to be understood as meaning that between the first measuring step and the irradiation or the irradiation and the second measuring step, at most a transport of the metal-ceramic substrate takes place, preferably of less than 2 m, particularly preferably less than 1 m and especially preferably less than 0.5 m, but no further treatment steps. Furthermore, it is conceivable that a groove and/or a series of holes, i.e. a perforation, is formed to form a structure serving as a predetermined breaking point.

According to a preferred embodiment of the present invention, it is provided that the first measurement step and/or the second measurement step is performed by means of a non-destructive optical measurement method. In particular, a distance from the sensor to a surface area of the metal-ceramic substrate, detected by the sensor, is determined by means of a first or second sensor, for example using interferometric methods. For example, by means of a distance determined in this way between the first sensor/second sensor and a substrate support on which the metal-ceramic substrate is positioned, and by means of a distance determined in this way between the first sensor/second sensor and a side of the ceramic layer facing away from the substrate support, the position of the ceramic layer can be used for optimized focusing during irradiation. The surface topography of the metal-ceramic substrate can then be successively recorded by means of a relative movement between the metal-ceramic substrate and the first/second sensor along a scan direction that runs in particular parallel to the main extension plane, and repeated recording of distances.

For example, the first sensor and the second sensor are identical in construction. An example of a first sensor and/or second sensor is the ConoPoint10-HD sensor from Optimet®. Preferably, a lens, for example with a focal length between 40 and 70 mm, is arranged between the first sensor and/or the second sensor in order to optimize the imaging properties for the application. Furthermore, it is advantageously possible to use the information acquired by means of the first measuring step and/or the second measuring step for quality control and/or to provide it to a subsequent customer of the divided metal-ceramic substrate section, for example in the form of a corresponding data package. Preferably, the metal-ceramic substrate for the first and/or second measurement step is arranged below the first sensor and/or second sensor in a direction perpendicular to the main extension plane, so that the first sensor and/or the second sensor detects the metal-ceramic substrate to be measured with a top view. It is also conceivable that a confocal microscopy method is used to perform the first measurement step and/or second measurement step.

In a further embodiment of the present invention, it is provided that the metal-ceramic substrate is conveyed along a conveying path for transfer to the first process step, the irradiation step and/or the second process step, wherein the metal-ceramic substrate is positioned on a rotating carrier, in particular a rotary table, during conveyance along the conveying path. This allows the first process step, the irradiation step and the second process step to share a common reference system. Furthermore, it is possible to subject other metal-ceramic substrates, which are also mounted on the rotating carrier, to the first or the second process step during the irradiation of the metal-ceramic substrate.

Preferably, the first measurement step and/or the second measurement step is carried out on one or more further metal-ceramic substrates during the irradiation of the metal-ceramic substrate. In this way, it is advantageous to use the service life resulting from the irradiation step to carry out the first measurement step and/or the second measurement step. The first and/or second measurement step can be carried out in a correspondingly time-saving manner. Furthermore, it is provided that when performing the irradiation of the metal-ceramic substrate, the first measuring step and/or the second measuring step the respective treatments or measurements are performed in such a way that generated stray light, e.g. when irradiating to generate the structure, does not interfere with the other processes in each case. For example, potential beam passages for scattered light are specifically blocked or the wavelengths of the individual processes are matched to each other so that the scattered light from one process does not interfere with another.

It is expediently provided that the first measurement step comprises an image processing recognition and/or a focus position measurement and/or a substrate thickness determination. In particular, it is provided to determine the position of the ceramic layer by means of the focus position measurement, whereby a focusing used during irradiation can be adjusted specifically to the position of the ceramic layer, in particular of a first side of the ceramic layer facing the laser light source during irradiation of the ceramic layer. Preferably, the first measuring step is provided to detect an edge region of the metal-ceramic substrate, which preferably has a metal-free ceramic layer portion.

Furthermore, it is preferably provided that in the second process step includes

a scribe depth measurement and/or

a determination of the centerline of a structure created by irradiation.

By means of the scribe depth measurement, a depth of the structure created by the illumination can be detected, while by means of the centerline determination, the position of the created structure between two adjacent metal-ceramic substrate sections can be detected. In particular, an iso-trench region or isolation trench region is provided between the two adjacent metal-ceramic substrate sections, i.e. a region that is free of metal, for example by etching the metal layer. Preferably, in the second process step, the etching flanks that delimit the iso-trench region or isolation trench region are measured. It is also conceivable that in the second process step the iso-trench region or isolation trench region with the etching flanks adjoining the isograb region or isolation trench region on both sides in the scan direction is measured more precisely than other regions of the metal-ceramic substrate.

In another embodiment of the present invention, it is contemplated that an ultrashort pulse laser source is used. For example, the ultrashort pulse laser source generates pulses with a pulse duration of 0.1 ps to 100 ps, the pulses being emitted at a frequency of 350 to 650 kHz. Preferably, pulses with a wavelength from the infrared range are used and the size of a laser light diameter on the ceramic layer measured parallel to the main extension plane is 20 to 80 μm, preferably less than 50 μm. Furthermore, the pulse energy of the pulses used is an energy between 100 μJ and 300 μJ.

Preferably, a tapered, in particular v-shaped or wedge-shaped, predetermined breaking point is generated. It is conceivable that the position and dimensioning of the focusing can be specifically adjusted by appropriate beam guidance, for example by lenses, in order to produce a wedge-shaped predetermined breaking point which has a positive effect on the subsequent breaking process when separating the metal-ceramic substrate sections.

A further object of the present invention is a system for carrying out the process according to the invention, comprising.

a transport means for conveying the metal-ceramic substrate along the conveying path

a light source for irradiating the metal-ceramic substrate by means of laser light

a first sensor for performing the first measurement step and/or a second sensor for performing the second measurement step,

wherein the first sensor is arranged in front of the light source as seen along the conveying path and/or the second sensor is arranged behind the light source as seen along the conveying path. All the features described for the method and their advantages can be applied mutatis mutandis to the system and vice versa.

A further object of the present invention is a metal-ceramic substrate produced by the process according to the invention. All of the features described for the process and the advantages thereof can be applied mutatis mutandis to the metal-ceramic substrate and vice versa. In particular, the produced metal-ceramic substrate has a predetermined breaking point between two adjacent metal-ceramic substrate sections.

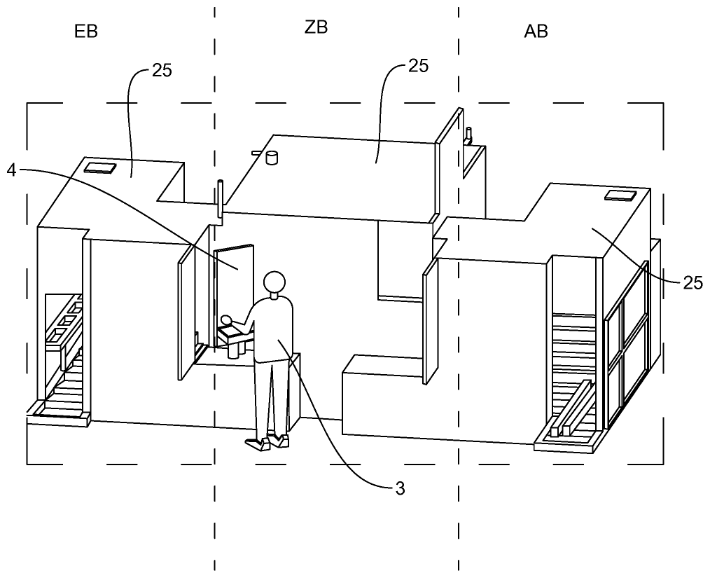

With reference now to the Figures, FIG. 1 schematically shows part of a system for the production and processing of metal-ceramic substrates 1. Such metal-ceramic substrates 1 preferably serve as carriers of electronic or electrical components which can be connected to the metal-ceramic substrate 1. Essential components of such a metal-ceramic substrate 1 are a ceramic layer 11 extending along a main extension plane HSE and a metal layer 12 bonded to the ceramic layer 11. The ceramic layer 11 is made of at least one material comprising a ceramic. In this case, the metal layer 12 and the ceramic layer 11 are arranged one above the other along a stacking direction extending perpendicularly to the main extension plane HSE and, in a manufactured state, are bonded to one another via a bonding surface. Preferably, the metal layer 12 is then structured to form conductor tracks or connection points for the electrical components. For example, this structuring is etched into the metal layer 12. In advance, however, a permanent bond, in particular a material bond, must be formed between the metal layer 12 and the ceramic layer 11.

In order to permanently bond the metal layer 12 to the ceramic layer 11, the equipment for manufacturing the metal-ceramic substrate 1 comprises a furnace in which a precomposite of metal and ceramic is heated to achieve the bond. For example, the metal layer 12 is a metal layer 12 made of copper, and the metal layer 12 and the ceramic layer 11 are bonded together using a DCB (direct copper bonding) bonding process. Alternatively, the ceramic layer 11 and the metal layer 12 can also be bonded together by means of an active brazing process (ABM).

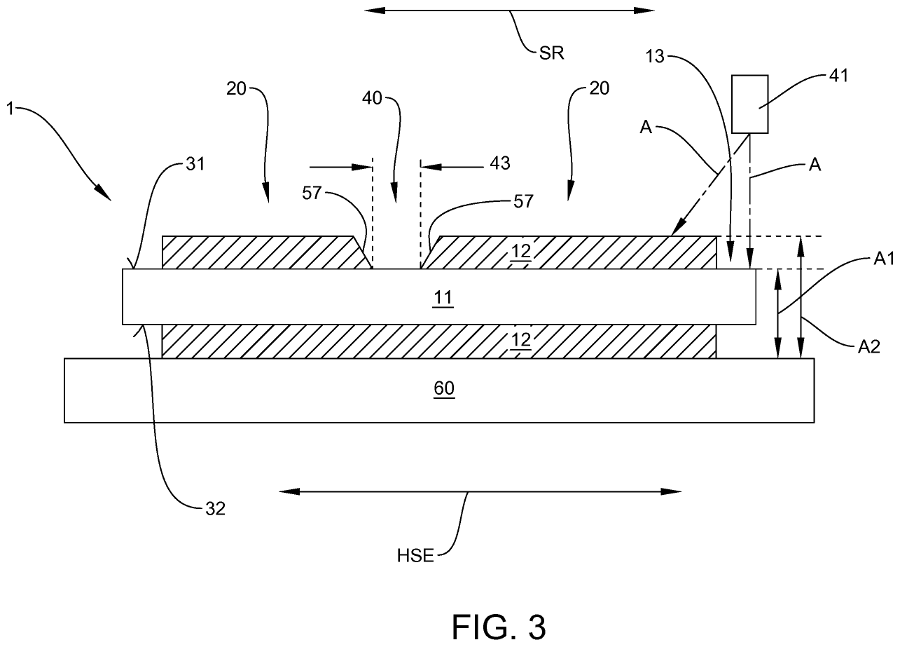

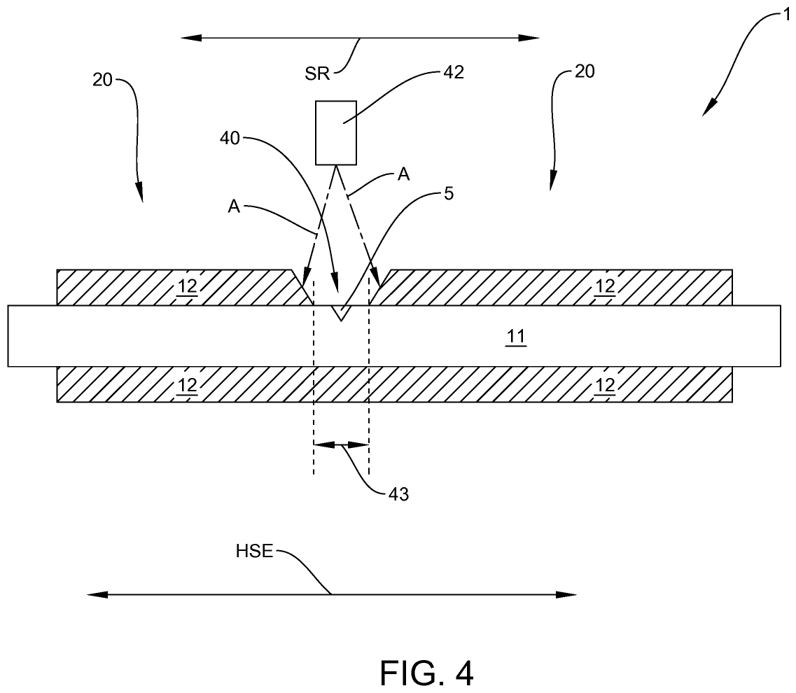

FIG. 1 shows in particular a part of an installation for the production and processing of metal-ceramic substrates 1, identified in more detail in FIGS. 3 and 4, which is downstream of the bonding of the metal layer 12 to the ceramic layer 11. In particular, after bonding the metal layer 12 to the ceramic layer 11, a plurality of metal-ceramic substrate sections 20 are separated from each other by singulation. Preferably, a predetermined breaking point 5 (see FIG. 4) is implemented in the metal-ceramic substrate 1 for singling into the plurality of metal-ceramic substrate sections 20 separated from each other. To form the predetermined breaking point 5, the metal-ceramic substrate 1 is irradiated with a laser light source. In this process, a structure, in particular a recess, notch or a crack or groove, is created in the ceramic layer 11 by means of the laser light source. Preferably, the recess forms a groove, in particular a v-shaped groove, the longitudinal extension of which defines a predetermined course of the breaking point. Alternatively or additionally, it is also conceivable that the predetermined breaking point course is formed by the formation of several holes or slots arranged one behind the other. Preferably, a pulse laser source, in particular an ultrashort pulse laser source, is used as the light source for processing the metal-ceramic substrate 1. For example, the ultrashort pulse laser source generates pulses with a pulse duration of 0.1 ps to 100 ps, the pulses being emitted at a frequency of 350 to 650 kHz.

Furthermore, the predetermined breaking point 5 is generated in an iso-trench region or isolation trench region 40 between two metal-ceramic substrate sections 20, i.e. in a region, on a first side 31 of the ceramic layer 11 facing the light source, which is preferably free of metallization or metallization layer 12. In this context, it is preferably provided that a metal layer 12 is provided on the second side 32 opposite the first side 31, which metal layer 12 is preferably formed continuously, i.e. is free of structuring.

After the formation of the predetermined breaking point 5, the individual metal-ceramic substrate sections 20 can be separated or separated from each other by breaking off at the respective predetermined breaking point 5, i.e. along the predetermined course of the breaking line.

In order to reduce the scrap of metal-ceramic substrates 1 or metal-ceramic substrate sections 20, which are destroyed or damaged, for example, during breaking, it has proven advantageous to subject the metal-ceramic substrate 1 to a first measurement step and/or a second measurement step before breaking or separating. In particular, it is provided that the metal-ceramic substrate 1 is conveyed along a conveying path F and the metal-ceramic substrate 1 is subjected to the first measuring step time-wise before irradiation with the laser light source and to the second measuring step time-wise after irradiation. Preferably, the first measurement step is performed immediately before and/or the second measurement step is performed immediately after the irradiation. By “immediately before or after” is meant here in particular that between the first measuring step and the irradiation, or the irradiation and the second measuring step, the metal-ceramic substrate 1 is merely transported or conveyed. Furthermore, the first measuring step, the second measuring step and/or the irradiating step take place at respective different positions along the conveying path F. It is further provided that the first measuring step, the second measuring step and/or the irradiating step take place at a time in which a conveying movement along the conveying path F is interrupted, i.e. the metal-ceramic substrate 1 is at rest during the first measuring step, the second measuring step and/or the irradiating step. Preferably, the first and/or second measuring step is a non-destructive optical measuring method that can be used to determine the surface topography of the metal-ceramic substrate 1.

The individual metal-ceramic substrates 1 in the system are fed to a central area ZB via an insertion area EB and discharged from the central region ZB via a discharge area AB. Preferably, the insertion area EB, the central region ZB and/or the discharge region AB each comprise a housing 25. The housing 25 is particularly advantageous for the central region ZB, since it can prevent stray light from leaving the central region ZB or entering the central region ZB. Preferably, the first measuring step, the second measuring step and the irradiation take place in the central region ZB. Furthermore, it is provided that a user 3 of the system receives information about the first measuring step, the second measuring step and/or the irradiation via a display device 4 or a display.

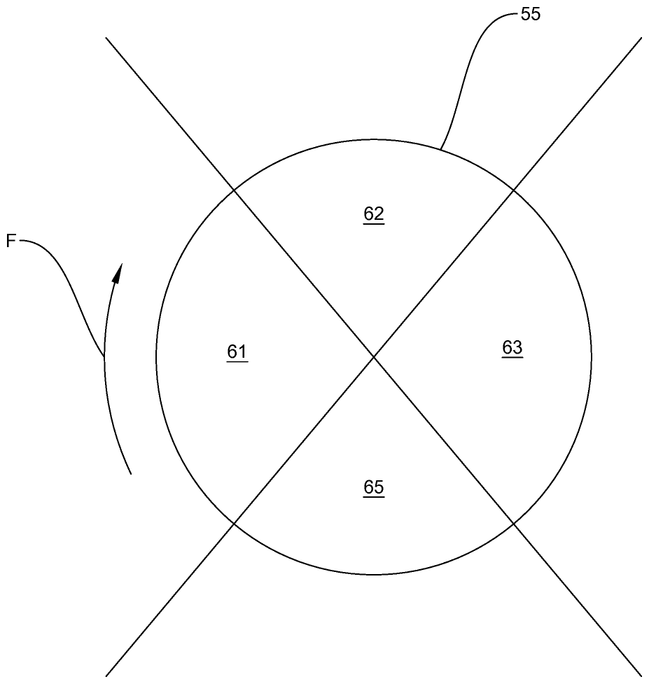

FIG. 2 shows a schematic representation of the method for processing metal-ceramic substrates 1. In particular, it is provided that a rotating carrier 55, in particular a rotary table, is used here for conveying the metal-ceramic substrate 1. In addition to an unloading and/or loading area 65 of the carrier 55, a first processing area 61 for the first measuring step, a second processing area 62 for irradiation and a third processing area 63 for the second process step are arranged successively along the circumference of the carrier 55. Thus, when the carrier 55 is rotated, the metal-ceramic substrates 1 are successively transported from the loading area 65 to the first processing area 61, from the first processing area 62 to the second processing area 63, and from the second processing area 63 to the area for unloading 65.

In this case, the transport along the conveying path F by means of the rotating carrier 55 does not take place continuously, but sequentially, i.e. the rotating carrier 55 is moved on in such a way that with each rotation the next station, i.e. the next processing area 61, 62, 63, 65, is reached, and then a pause in the conveying movement is made for carrying out the first measuring step, the second measuring step and/or the irradiation. In particular, it is provided that the carrier 55 performs a 90° rotation for conveying between each station and then the rotational movement is paused so that the first measuring step, the irradiation step and/or the second measuring step can be performed simultaneously and then the respective metal-ceramic substrates 1 are fed to the next processing area 61, 62, 63 and 65 by a renewed 90° rotation. Furthermore, it is provided that several metal-ceramic substrates 1, in particular metal-ceramic substrates 1 arranged next to each other, are processed in one of the processing areas 61, 62, 63 and 65 in each case.

As soon as the target position is reached, the irradiation, the first process step, the second process step, the unloading and/or loading is carried out. Preferably, the first process step, the second process step, the loading, the unloading and/or the irradiation are carried out at least partially simultaneously, i.e. during the irradiation of the metal-ceramic substrate 1 or several metal-ceramic substrates 1 in the second processing area 62, the first measuring process and/or the second measuring process are carried out simultaneously in the first processing area 61 and/or in the third processing area 63 on further metal-ceramic substrates 1. Furthermore, it is preferably provided that the loading and/or unloading area 65, the first processing area 61, the second mach processing ining area 62 and the third processing area 63 are arranged equidistantly to one another along the circumference of the substrate 55. For example, the first processing area 61 and the third processing area 63 are opposite each other.

For example, the first measurement step is an IMAGE PROCESSING recognition, a focus position measurement and/or a determination of the layer thickness measurement. In this way, the current position of the metal-ceramic substrate 1 to be irradiated, in particular the position of the ceramic layer 11 or of the first side 31 of the ceramic layer 11, can be determined in an advantageous manner immediately before irradiation, in order to take this position or orientation into account in an advantageous manner during subsequent irradiation. The focus position measurement serves in particular to identify the plane of the ceramic layer 11, whereby the light beam can be focused on this plane in the desired manner during subsequent irradiation.

In particular, the surface topography is determined in the first measurement step by means of a first sensor 41 before irradiation and the surface topography is determined by means of a second sensor 42 after irradiation. The first sensor 41 and/or the second sensor 42 can be of the same or identical type. To determine the surface topography, it is preferably provided that the first sensor 41 and/or the second sensor 42 each determine a distance A between an observed surface area on the metal-ceramic substrate 1 and the first sensor 41 or second sensor 42. By offsetting along a scanning direction SR and repeatedly recording the distances A or a wide recording area, the surface topography can be recorded. In this context, the first sensor 41 and/or the second sensor 42 can, for example, detect distances A along a projection direction running perpendicular to the main extension plane HSE or obliquely to this projection direction, whereby the obliquely detected distances A can preferably be correspondingly adjusted to the distances A determined along the projection direction by means of a correction. For example, the first sensor 41 and/or second sensor 42 is a ConoPoint10-HD sensor from Optimet®. In this case, a lens 73, in particular with a focal length of between 30 and 70 mm, preferably of 40 mm, is used to guide the beam of light used to determine the distances. The lens 73 is arranged between the first sensor 41 or the second sensor 42 and the area to be recorded.

The focal position measurement and layer thickness measurement as the first measurement method are shown by way of example in FIG. 3. Here, the distance A of the ceramic layer 11 relative to a substrate receptacle 60 is determined by means of a first sensor 41. In the example shown, a continuous metal layer 12 is provided on the second side 32 of the ceramic layer 11, which also influences the position of the ceramic layer 11. In particular, the first sensor 41 is arranged in such a way that a metal-free ceramic layer section 13, in particular at the edge of the metal-ceramic substrate 1, is detected together with the substrate receptacle 60. In a first measurement, the position of the first side 31 of the ceramic layer 11 relative to the substrate receptacle 60 can then be determined by taking the substrate receptacle 60 as a reference and forming a difference from a distance A between the first sensor 41 and the substrate receptacle 60 and a distance A between the first sensor 41 and the first side 31 of the ceramic layer 11, which difference corresponds to a primary distance A1 of the first side 31 relative to the substrate receptacle 60.

By determining the distance A between the metal layer 12 on the first side 31 of the ceramic layer 11 and the first sensor 41, it is also possible to obtain, in an analogous manner, information about a secondary distance A2 between the substrate receptacle 60 serving as a reference or zero position and a side of the metal layer 12 facing away from the ceramic layer 11 and arranged on the first side 31 of the ceramic layer 11. Thus, in addition to information about the position of the ceramic layer 11, it is possible to obtain information about a layer thickness of that metal layer 12 which is bonded to the first side 31 of the ceramic layer 11, as well as a total substrate thickness of the metal-ceramic substrate 1.

In the second measurement step following the irradiation, a depth of the structure created by the irradiation is determined by means of a scribe depth measurement or the position of the structure between two metal-ceramic substrate sections 20 separated from each other after fracturing is determined by means of a determination of the centerline. In particular, this thus involves a measurement of a structure created within the iso-trench region or isolation trench region 40 by the irradiation, which forms the predetermined breaking point 5. Preferably, in this case, the second sensor 42 is guided over the metal-ceramic substrate 1 in a scanning direction SR running parallel to the main extension plane HSE, and the surface topography, preferably of each of the metal-ceramic substrate portions 20, is detected by continuously detecting the distances A of the second sensor 42 from the image area above the metal-ceramic substrate 1 detected by the second sensor 42. Furthermore, it is preferably provided that the metal-ceramic substrates 1 are completely measured by means of the second process step or that the metal-ceramic substrate sections 20 are only scanned in strips. For this purpose, at least one measuring point is recorded from each metal-ceramic substrate section 20 that is to be provided later individually.

FIG. 4 shows an example of a second measurement step. Here it is provided that the surface topography of two metal-ceramic substrate sections 20 arranged next to each other in the metal-ceramic substrate 1 is detected, whereby in particular the iso-trench region or isolation trench region 40 and etching flanks 57 lying opposite each other in the scan direction SR are detected in the second measurement step, preferably completely. As a result, a distance between the mutually opposing metal layers 12 of the adjacent metal-ceramic substrate sections 20 can then be inferred on the basis of the course of the etching flanks 57 or the ceramic layer 11 in the iso-trench region or insulation trench region 40. Consequently, a width 43 of the iso-trench region or isolation trench region 40 can be detected by this distance. Moreover, in addition to a scribe depth, it is also possible to determine the position of the structure created by the irradiation. The latter can then be used to check whether the generated structure is centered between the adjacent metal-ceramic substrate sections 20 as viewed in the scan direction SR.

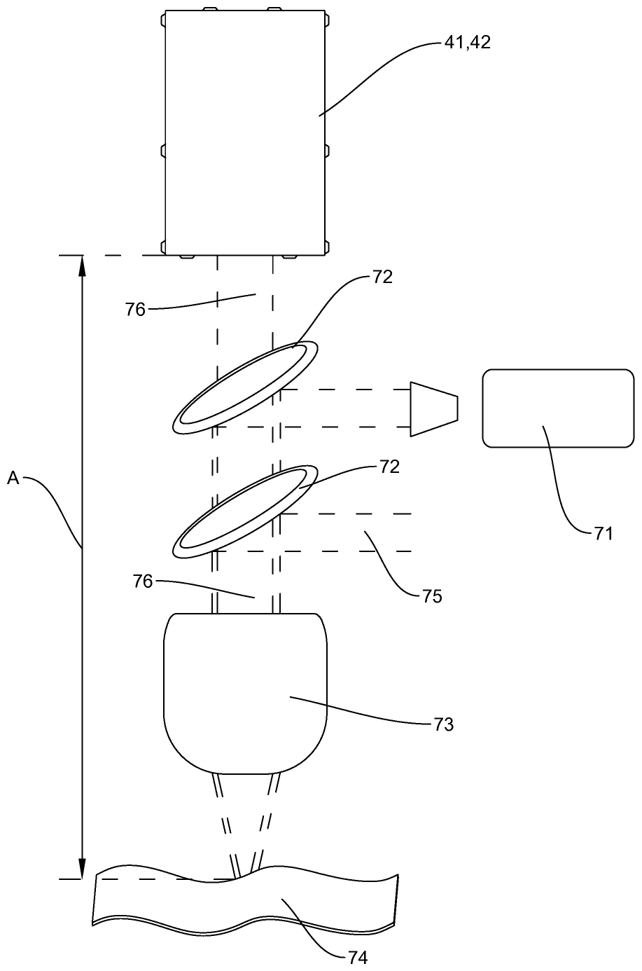

FIG. 5 shows a general setup for measuring the distance A between a sensor 41, 42 and a surface 74. With such a setup, for example, the first and/or second measurement step can be performed. In this case, the first sensor 41 and/or second sensor 42 is arranged over the surface 74 to be examined. In the area between the surface 74 and the first sensor 41 and/or second sensor 42, a lens 73, in particular a microscope objective, is arranged between the surface 74 and the first sensor 41 and/or second sensor 42 for beam guiding a beam path 76, in particular for focusing. By means of a dichroic mirror 72 in each case, a measuring laser beam 75 is coupled into the beam path 76 or light is coupled out to a camera 71, which can preferably also serve to illuminate the surface 74.

### LIST OF REFERENCE SIGNS

1 metal ceramic substrate

3 user

4 display device

5 predetermined breaking point

11 ceramic layer

12 metal layer

13 metal-free ceramic layer section

20 metal ceramic substrate section

25 housing

31 first side

32 second side

40 iso-trench region or isolation trench region

41 first sensor

42 second sensor

43 Width of the iso-trench region or isolation trench region

55 carriers

57 etching flanks

60 substrate receptable

61 first processing area

62 second processing area

63 third processing area

65 unloading and loading area

71 camera

72 dichroic mirror

73 lens

74 surface

75 measuring laser beam

76 beam path

A distance

F conveying path

A1 primary distance

A2 secondary distance

SR scan direction

HSE main extension plane

EB insertion area

ZB central area

AB discharge region

1. A method of processing a metal-ceramic substrate (1), comprising:
processing the metal-ceramic substrate (1) by irradiating the metal-ceramic substrate (1) with laser light, in particular to form a predetermined breaking point (5);
wherein in a first measuring step preceding the irradiation and/or in a second measuring step following the irradiation a surface topography of the metal-ceramic substrate (1) is measured at least in regions, wherein the surface topography is a profile course of the metal-ceramic substrate along its main extension plane, wherein the method comprises
a scribe depth measurement and/or
a determination of the centerline of a structure created by irradiation
characterized by
an ultrashort pulse laser source is used in the irradiation.

2. The method according to claim 1, wherein the first measuring step and/or the second measuring step is carried out by means of a non-destructive, optical measuring method.

3. Method according to claim 1, wherein the metal-ceramic substrate (1) is conveyed along a conveying path (F) for transfer to the first process step, the irradiation and/or the second process step, wherein the metal-ceramic substrate (1) is positioned on a rotating carrier (55), in particular a rotary table, during conveyance along the conveying path (F).

4. The method according to claim 1, wherein during the irradiation of the metal-ceramic substrate (1) the first measuring step and/or the second measuring step is carried out on one or more further metal-ceramic substrates (1).

5. The method according to claim 1,
wherein the first surveying step comprises
an image processing detection and/or
a focus position measurement and/or
a substrate thickness determination.

6. (canceled)

7. (canceled)

8. The method according to claim 1, wherein a tapering predetermined breaking point (5) is produced.

9. A system for carrying out the process according to claim 1, comprising:
a conveying means for conveying the metal-ceramic substrate (1) along the conveying path (F);
a light source for irradiating the metal-ceramic substrate by means of laser light, and
a first sensor (41) for carrying out the first measurement step and/or a second sensor (42) for carrying out the second measurement step, the first sensor (41) being arranged in front of the light source as seen along the conveying path (F) and/or the second sensor (42) being arranged behind the light source as seen along the conveying path, characterized in that the system is configured that an ultrashort pulse laser source is used during irradiation.

10. (canceled)

11. The method according to claim 8, wherein a v-shaped or wedge-shaped predetermined breaking point (5) is produced.
